(19) United States
(12) Patent Application Publication
(10) Pub. No.: US 2020/0134653 A1
(43) Pub. Date: Apr. 30, 2020

(54) ASSESSMENT METHOD, REWARD SETTING METHOD, COMPUTER, AND PROGRAM

(71) Applicant: FRONTEO, Inc., Tokyo (JP)

(72) Inventors: Sayaka NISHINO, Tokyo (JP); Ryota TAMURA, Tokyo (JP); Shinya IGUCHI, Tokyo (JP)

(21) Appl. No.: 16/590,670

(22) Filed: Oct. 2, 2019

(30) Foreign Application Priority Data
Oct. 29, 2018 (JP) 2018-203079

(51) Int. Cl. G06Q 30/02; G09B 19/00

(52) U.S. Cl. CPC G06Q 30/0217; G09B 19/00

(57) ABSTRACT

An assessment method which is capable of appropriately assessing review ability of a reviewer and a reward setting method which is capable of appropriately setting a reward to be paid to the reviewer are realized. A computer includes a memory and a controller, and the controller executes efficiency evaluation processing of evaluating review efficiency of a reviewer to be assessed in accordance with a predicted review period of each piece of electronic data and an actual review period, accuracy evaluation processing of evaluating review accuracy of the reviewer to be assessed by examining a review result by the reviewer to be assessed, and assessment processing of assessing review ability of the reviewer to be assessed in accordance with the review efficiency evaluated in the efficiency evaluation processing and the review accuracy evaluated in the accuracy evaluation processing.

### BACKGROUND OF THE INVENTION

### Field of the Invention

The present disclosure relates to an assessment method, or the like, for assessing ability of a reviewer who reviews a data set, and a reward setting method, or the like, for setting a reward for a reviewer who reviews a data set.

### Description of the Related Art

At companies, there is a case where it is necessary to do work of reviewing (hereinafter, referred to as “review work”) a data set including at least one piece of electronic data. For example, in review work for discovery, it is necessary to pick up electronic data to be submitted to a US federal court (for example, electronic data which satisfies predetermined extraction conditions designated by an attorney) among an enormous number of pieces of electronic data accumulated in a company. At a company where review work is done or at a company which undertakes review work, a reviewer is requested to do the review work by a reward being paid. At this time, the reward to be paid to the reviewer has been conventionally set in accordance with a period taken to do the review work (hereinafter, referred to as a “review period”) (see International Publication No. WO 2017/068750).

However, in a conventional reward setting method in which a reward to be paid to a reviewer is set in accordance with a review period, there are the following problems. That is, the reviewer receives a greater reward if the reviewer takes more time to do review work. Therefore, there is a possibility that some reviewers unreasonably take a lot of time to do review work and unreasonably receive a lot of rewards. Further, rewards of an equal amount are paid to a reviewer with low review ability and to a reviewer with high review ability if it takes the same time to do review work. Therefore, it is impossible to provide motivation to improve review ability to reviewers, which may result in degradation of quality of review work.

To solve these problems, it is required to set a reward to be paid to a reviewer in accordance with review ability of the reviewer. However, there is no assessment method which is capable of appropriately assessing the review ability of the reviewer.

One aspect of the present disclosure has been made in view of the above-described problems, and is directed to realizing an assessment method which is capable of appropriately assessing the review ability of the reviewer and a reward setting method which is capable of appropriately setting a reward to be paid to the reviewer.

### SUMMARY OF THE INVENTION

To solve the above-described problems, an assessment method according to one aspect of the present disclosure is an assessment method for assessing review ability of a reviewer to be assessed who reviews a data set using a computer including a controller and a memory which stores the data set including at least one piece of electronic data, the assessment method including efficiency evaluation processing executed by the controller evaluating review efficiency of the reviewer to be assessed in accordance with a predicted review period of each piece of electronic data and an actual review period actually taken for the reviewer to be assessed to do review work on the electronic data, accuracy evaluation processing executed by the controller evaluating review accuracy of the reviewer to be assessed by examining a review result obtained by the reviewer to be assessed reviewing the data set, and assessment processing executed by the controller assessing the review ability of the reviewer to be assessed in accordance with the review efficiency evaluated in the efficiency evaluation processing and the review accuracy evaluated in the accuracy evaluation processing.

To solve the above-described problems, a computer according to one aspect of the present disclosure is a computer including a memory which stores a data set including at least one piece of electronic data, and a controller, and assessing review ability of a reviewer to be assessed who reviews the data set, the controller executing efficiency evaluation processing of evaluating review efficiency of the reviewer to be assessed in accordance with a predicted review period of each piece of electronic data and an actual review period actually taken for the reviewer to be assessed to do review work on the electronic data, accuracy evaluation processing of evaluating review accuracy of the reviewer to be assessed by examining a review result obtained by the reviewer to be assessed reviewing the data set, and assessment processing of assessing the review ability of the reviewer to be assessed in accordance with the review efficiency evaluated in the efficiency evaluation processing and the review accuracy evaluated in the accuracy evaluation processing.

According to an assessment method according to one aspect of the present disclosure, it is possible to appropriately assess review ability of a reviewer to be assessed.

### BRIEF DESCRIPTION OF THE DRAWINGS

FIG. 1 is a block diagram illustrating a configuration of a computer according to Embodiment 1 of the present disclosure;

FIG. 2 is a flowchart illustrating flow of a reward setting method to be implemented using the computer illustrated in FIG. 1;

FIG. 3 is a table indicating an example of accuracy evaluation processing included in the reward setting method illustrated in FIG. 2;

FIG. 4A is a flowchart illustrating flow of the accuracy evaluation processing included in the reward setting method illustrated in FIG. 2;

FIG. 4B is a table indicating an example of the accuracy evaluation processing;

FIG. 4C is a table indicating an example of the accuracy evaluation processing;

FIG. 5A is a graph indicating an example of assessment processing included in the reward setting method illustrated in FIG. 2;

FIG. 5B is a graph indicating an example of assessment processing included in the reward setting method illustrated in FIG. 2;

FIG. 6 is a graph indicating an example of calculation processing included in the reward setting method illustrated in FIG. 2;

FIG. 7 is a flowchart illustrating flow of a construction method of a prediction model which can be implemented as part of the reward setting method illustrated in FIG. 2;

FIG. 8A is a flowchart illustrating a first specific example of setting processing included in the construction method illustrated in FIG. 2;

FIG. 8B is a table indicating the first specific example of the setting processing included in the construction method illustrated in FIG. 2;

FIG. 9A is a flowchart illustrating a second specific example of the setting processing included in the construction method illustrated in FIG. 2;

FIG. 9B is an example of a multiple regression expression created by the setting processing illustrated in FIG. 9A;

FIG. 10A is a flowchart illustrating a third specific example of the setting processing included in the construction method illustrated in FIG. 2;

FIG. 10B is an example of a regression tree created in the setting processing illustrated in FIG. 10A;

FIG. 11 is an example of an output image output using an output device; and

FIG. 12 is an example of the output image output using the output device.

### DETAILED DESCRIPTION OF THE PREFERRED EMBODIMENTS

### <Configuration of Computer>

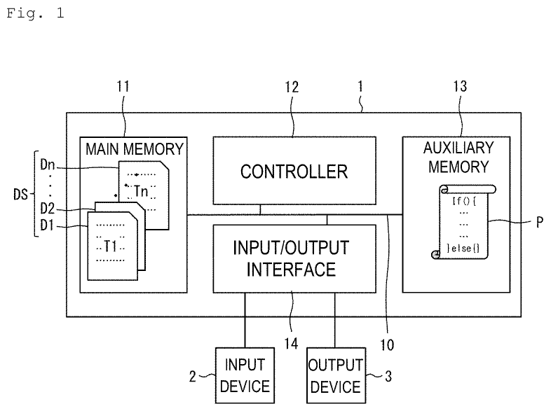

A configuration of a computer 1 according to an embodiment of the present disclosure will be described with reference to FIG. 1. FIG. 1 is a block diagram illustrating the configuration of the computer 1.

As illustrated in FIG. 1, the computer 1 includes a bus 10, a main memory 11, a controller 12, an auxiliary memory 13 and an input/output interface 14. The controller 12, the auxiliary memory 13 and the input/output interface 14 are connected to each other via the bus 10. As the main memory 11, for example, one or more semiconductor random access memories (RAMs) are used. As the controller 12, for example, one or more central processing units (CPUs) are used. As the auxiliary memory 13, for example, a hard disk drive (HDD) is used. As the input/output interface 14, for example, a universal serial bus (USB) interface is used.

To the input/output interface 14, for example, an input device 2 and an output device 3 are connected. As the input device 2, for example, a keyboard and a mouse are used. As the output device 3, for example, a display and a printer are used. Note that the computer 1 may incorporate a keyboard which functions as the input device 2 and a display which functions as the output device 3, in a similar manner to a laptop computer. Further, the computer 1 may incorporate a touch panel which functions as the input device 2 and the output device 3, in a similar manner to a smartphone or a tablet computer.

In the auxiliary memory 13, a program P for causing the computer 1 to implement an assessment method S0 and a reward setting method S1 which will be described later is stored. The controller 12 executes each step included in the reward setting method S1 which will be described later by expanding the program P stored in the auxiliary memory 13 on the main memory 11 and executing each command included in the program P expanded on the main memory 11. Further, in the auxiliary memory 13, a data set DS to be referred to by the computer 1 in the reward setting method S1 which will be described later is stored. The data set DS is a set of at least one piece of electronic data D1, D2, . . . , Dn (n is an arbitrary natural number of one or greater). Each piece of electronic data Di includes text Ti as content. Examples of such electronic data can include, for example, TXT data (plain text data), RTF data (rich text data), HTML data, XML data, PDF data, DOC data and EML data. The controller 12 expands each piece of electronic data Di (i=1, 2, . . . , n) stored in the auxiliary memory 13 on the main memory 11 and refers to this data in each step included in the reward setting method S1 which will be described later.

Note that, while an embodiment has been described where the computer 1 implements the reward setting method S1 which will be described later using the program P stored in the auxiliary memory 13 which is an internal storage medium, the embodiment is not limited to this. That is, it is also possible to employ an embodiment where the computer 1 implements the reward setting method S1 which will be described later using the program P stored in an external recording medium. In this case, as the external recording medium, a “non-transitory tangible medium” which can be read by the computer 1, for example, a tape, a disk, a card, a semiconductor memory, a programmable logic circuit, or the like, can be used. Alternatively, it is also possible to employ an embodiment where the computer 1 implements the reward setting method S1 which will be described later using the program P acquired via a communication network. In this case, as the communication network, for example, the Internet, LAN, or the like, can be used.

### <Reward Setting Method>

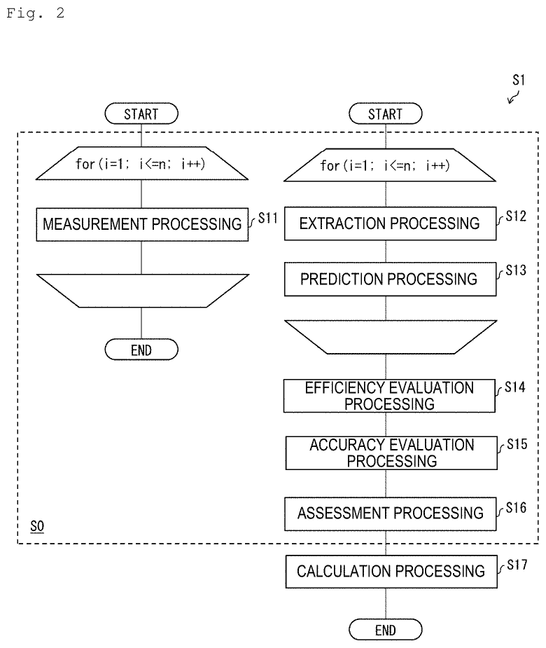

The reward setting method S1 of the reviewer to be assessed according to an embodiment of the present disclosure will be described with reference to FIG. 2. FIG. 2 is a flowchart illustrating flow of the reward setting method S1 of the reviewer to be assessed.

The reward setting method S1 is a method for setting a reward for the reviewer to be assessed who reviews the data set DS, using the computer 1. As illustrated in FIG. 2, the reward setting method S1 includes measurement processing S11, extraction processing S12, prediction processing S13, efficiency evaluation processing S14, accuracy evaluation processing S15, assessment processing S16 and calculation processing S17. The measurement processing S11 is, for example, processing to be performed while the reviewer to be assessed is doing review work. The extraction processing S12, the prediction processing S13, the efficiency evaluation processing S14, the accuracy evaluation processing S15, the assessment processing S16 and the calculation processing S17 are a series of processing to be performed after the reviewer to be assessed does review work. Note that as review work to be imposed on the reviewer to be assessed, here, work for judging whether or not each piece of electronic data Di included in the data set DS satisfies extraction conditions determined in advance (for example, whether or not each piece of electronic data Di relates to a specific case) is assumed.

Note that the above-described specific case includes all targets which require the above-described judgment on each piece of electronic data Di. The specific case may be, for example, a “lawsuit”. At this time, the above-described review work is, for example, work of selecting and collecting evidence occurring in association with discovery in a civil case in the U.S. That is, the review work is work in which a reviewer confirms respective pieces of electronic data Di possessed by a person concerned with the lawsuit (custodian), evaluates relevance between the respective pieces of electronic data Di and the lawsuit (specific case), and judges whether or not to employ the respective pieces of electronic data Di as evidence to be submitted to the court. Alternatively, the specific case may be, for example, a “disease”. At this time, the above-described review work is, for example, work in which a doctor confirms an X-ray image (each piece of electronic data Di) and judges relevance (for example, whether or not he/she has a disease) between each piece of electronic data Di and the disease (specific case). That is, the specific case may be any target for which relevance with each piece of electronic data Di is evaluated, and a range of the specific case is not limited.

The measurement processing S11 is processing of measuring a period taken for the reviewer to be assessed to actually review each piece of electronic data Di (hereinafter, referred to as an “actual review period”) τi. The measurement processing S11 is executed by the controller 12 of the computer 1.

The extraction processing S12 is processing of extracting an attribute value (for example, 100 characters) of an attribute (for example, the number of characters) selected in advance of text Ti included in the electronic data Di for each piece of electronic data Di included in the data set DS from the electronic data Di stored in the memory (the main memory 11 or the auxiliary memory 13). The extraction processing S12 is executed by the controller 12 of the computer 1.

Hereinafter, the attribute value extracted in the extraction processing S12 will be referred to as a feature amount, and a set of the attribute values extracted in the extraction processing S12 will be referred to as a feature amount group GC. This feature amount group GC can include (1) a first feature amount C1 indicating complexity of text T, (2) a second feature amount C2 indicating a size of the text T, and (3) a third feature amount C3 indicating emotionality of the text T.

Examples of the attribute value of the text T which can be utilized as the first feature amount C1 can include, for example, the number of types of words, the number of word classes, a type token ratio (TTR), a corrected type token ratio (CTTR), a Yule's K characteristic value, the number of dependencies, a ratio of numerical values, or the like. It is also possible to utilize combination of part or all of these attribute values indicating complexity of the text T as the first feature amount C1. Note that definition of these attribute values will be described later.

Examples of the attribute value of the text T which can be utilized as the second feature amount C2 can include, for example, the number of characters, the number of words, the number of sentences, the number of paragraphs, or the like. It is also possible to utilize combination of part or all of these attribute values indicating the size of the text T as the second feature amount C2. Note that definition of these attribute values will be described later.

Examples of the attribute value of the text T which can be utilized as the third feature amount C3 can include, for example, a degree of positiveness, a degree of negativeness, or the like. Here, the degree of positiveness indicates positiveness of the text T, and is, for example, defined by the number of times of appearance of a word determined in advance as a positive word in the text T. Further, the degree of negativeness indicates negativeness of the text T, and is, for example, defined by the number of times of appearance of a word determined in advance as a negative word in the text T.

Note that the feature amount group GC may include the number of times of appearance of each word class in the text T. For example, each word included in the text T may be classified into an alphabetic character, an unknown word, a noun, a verb, an adjective, an adverb, an interjection, a prefix, an auxiliary verb, a conjunction, a filler, a pronoun adjectival, a particle, a sign, a number and others, and the number of times of appearance of each word class in the text T may be included in the feature amount group GC.

The prediction processing S13 is processing of predicting a predicted review period ti of the electronic data Di on the basis of the feature amount group GC extracted in the extraction processing S12 for each piece of electronic data Di included in the data set DS. The prediction processing S13 is executed by the controller 12 of the computer 1 after the extraction processing S12 is executed.

To execute the prediction processing S13, the controller 12, for example, calculates the predicted review period ti of the electronic data Di from the feature amount group GC extracted in the extraction processing S12 in accordance with the prediction model constructed in advance. The prediction model to be utilized in the prediction processing S13 is a prediction model constructed through machine learning in which the feature amount group GC of the text Ti included in the electronic data Di is input and the predicted review period ti is output, and is, for example, extreme learning machine (ELM), support vector machine (SVR), a regression tree, XGBoost, random forest, a deep neural network (DNN), or the like. Note that the construction method S2 of the prediction model to be utilized in the prediction processing S13 will be described later with reference to different drawings.

The efficiency evaluation processing S14 is processing of evaluating review efficiency a of the reviewer to be assessed in accordance with the actual review period τ1, τ2, . . . , τn measured in the measurement processing S11, and the predicted review period t1, t2, . . . , to predicted in the prediction processing S13. The efficiency evaluation processing S14 is executed by the controller 12 of the computer 1 after the prediction processing S13 is executed.

To execute the efficiency evaluation processing S14, the controller 12, for example, (1) calculates the review efficiency ai from the actual review period τi on a basis of the predicted review period ti for each piece of electronic data Di, and (2) calculates the review efficiency a representing the calculated review efficiency ai for each piece of electronic data Di. Here, the review efficiency ai for each piece of electronic data Di may be, for example, a difference τi−ti between the actual review period τi and the predicted review period ti, or may be a ratio τi/ti of the actual review period τi and the predicted review period ti. Further, the review efficiency a may be, for example, a maximum value, a minimum value, an average value, a median value or a mode value of the review efficiency a1, a2, . . . , an.

The accuracy evaluation processing S15 is processing of evaluating review accuracy b of the reviewer to be assessed by examining the review result obtained by the reviewer to be assessed reviewing the data set DS. The accuracy evaluation processing S15 is executed by the controller 12 of the computer 1. The accuracy evaluation processing S15 may be executed after the extraction processing S12, the prediction processing S13 and the efficiency evaluation processing S14 are executed, or may be executed before the extraction processing S12, the prediction processing S13 and the efficiency evaluation processing S14 are executed.

To execute the accuracy evaluation processing S15, the controller 12, for example, compares a judgment result in the review work by the reviewer to be assessed with a judgment result in the review work by a reviewer other than the reviewer to be assessed. A specific example of the accuracy evaluation processing S15 will be described later with reference to different drawings.

The assessment processing S16 is processing of assessing review ability c of the reviewer to be assessed in accordance with the review efficiency a evaluated in the efficiency evaluation processing S14 and the review accuracy b evaluated in the accuracy evaluation processing S15. The assessment processing S16 is executed by the controller 12 of the computer 1 after the efficiency evaluation processing S14 and the accuracy evaluation processing S15 are executed. The controller 12, for example, assesses the review ability c so that the review ability c becomes higher as the review efficiency a is higher, and the review ability c becomes higher as the review accuracy b is higher. A specific example of the assessment processing S16 will be described later with reference to different drawings.

The calculation processing S17 is processing of setting a reward d for the reviewer to be assessed in accordance with the review ability c assessed in the assessment processing S16. The calculation processing S17 is executed by the controller 12 of the computer 1 after the assessment processing S16 is executed. The controller 12, for example, sets the reward d so that, when review ability c1 of a first reviewer is higher than review ability c2 of a second reviewer, a reward d1 to be paid to the first reviewer becomes more than a reward d2 to be paid to the second reviewer (that is, d1>d2). A specific example of the calculation processing S17 will be described later with reference to different drawings.

As described above, the reward setting method S1 according to the present embodiment includes assessment processing S16 of assessing the review ability c of the reviewer to be assessed on the basis of the review efficiency a and the review accuracy b of the reviewer to be assessed, and calculation processing S17 of setting the reward d for the reviewer to be assessed in accordance with the review ability c of the reviewer to be assessed, assessed in the assessment processing S16. Therefore, according to the reward setting method S1 according to the present embodiment, it is possible to appropriately evaluate the review ability c of the reviewer to be assessed and pay the reward d appropriately set in accordance with the review ability c to the reviewer to be assessed.

Note that the reward setting method S1 according to the present embodiment includes an assessment method S0 including the measurement processing S11, the extraction processing S12, the prediction processing S13, the efficiency evaluation processing S14, the accuracy evaluation processing S15 and the assessment processing S16. This assessment method S0 can be implemented independently of the calculation processing S17 (regardless of whether or not the calculation processing S17 is performed), as the assessment method for assessing ability of the reviewer to be assessed.

This assessment method S0 includes the efficiency evaluation processing S14 of evaluating the review efficiency a of the reviewer to be assessed on the basis of the predicted review period ti and the actual review period τi of each piece of electronic data Di, the accuracy evaluation processing S15 of evaluating the review accuracy b of the reviewer to be assessed on the basis of the review result obtained by the reviewer to be assessed reviewing the data set DS, and the assessment processing S16 of assessing the review ability c of the reviewer to be assessed on the basis of the review efficiency a evaluated in the efficiency evaluation processing S14 and the review accuracy b evaluated in the accuracy evaluation processing S15. Therefore, according to this assessment method S0, it is possible to appropriately assess the review ability c of the reviewer to be assessed in accordance with the review efficiency a and the review accuracy b of the reviewer to be assessed.

### Specific Example 1 of Accuracy Evaluation Processing

A first specific example of the accuracy evaluation processing S15 included in the reward setting method S1 illustrated in FIG. 2 will be described.

In the accuracy evaluation processing S15 according to the present specific example, the controller 12 of the computer 1 evaluates the review accuracy b of the reviewer to be assessed by comparing electronic data judged by the reviewer to be assessed (for example, a primary reviewer) as satisfying the extraction conditions with electronic data judged by a checker (for example, a secondary reviewer such as an attorney) as satisfying the extraction conditions in a partial data set DS′ including electronic data extracted from the data set DS. The review accuracy b evaluated in the accuracy evaluation processing S15 according to the present specific example can be, for example, an agreement rate between the electronic data judged by the reviewer to be assessed as satisfying the extraction conditions and the electronic data judged by the checker as satisfying the extraction conditions in the partial data set DS′

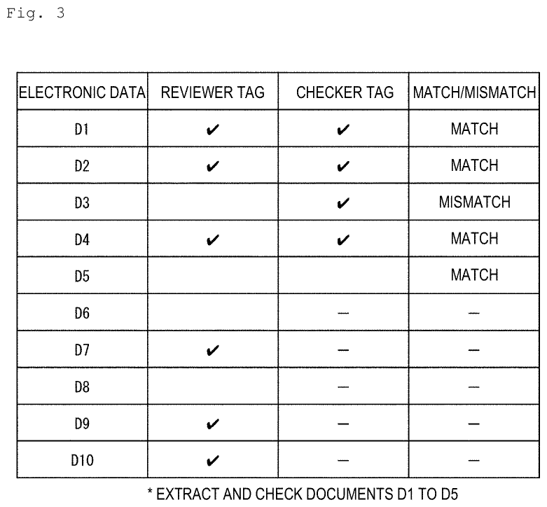

One example of the accuracy evaluation processing S15 according to the present specific example will be described below with reference to FIG. 3 using an example of a case where the data set DS includes ten pieces of electronic data D1 to D10 and the partial data set DS′ includes five pieces of electronic data D1 to D5. FIG. 3 is a table indicating one example of the accuracy evaluation processing S15 according to the present specific example.

In the example indicated in FIG. 3, the reviewer to be assessed judges whether or not each of ten pieces of electronic data D1 to D10 included in the data set DS satisfies the extraction conditions and provides tags to six pieces of electronic data D1, D2, D4, D7, D9 and D10 which are judged as satisfying the extraction conditions. In a similar manner, the checker judges whether or not each of five pieces of electronic data D1 to D5 included in the partial data set DS′ satisfies the extraction conditions and provides tags to four pieces of electronic data D1, D2, D3 and D4 which are judged as satisfying the extraction conditions. Concerning four pieces of electronic data D1, D2, D4 and D5, the review result by the reviewer to be assessed matches the review result by the checker. However, concerning the electronic data D3, because, while the reviewer to be assessed judges that the electronic data does not satisfy the extraction conditions, the checker judges that the electronic data satisfies the extraction conditions, the review results do not match. Therefore, the review accuracy b of the reviewer to be assessed is calculated as c=4/5.

### Specific Example 2 of Accuracy Evaluation Processing

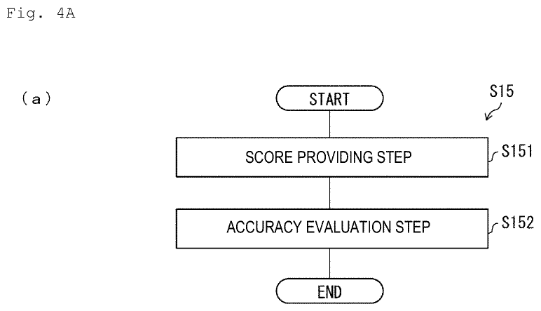

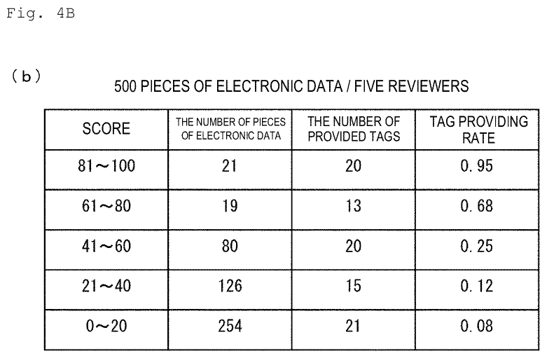

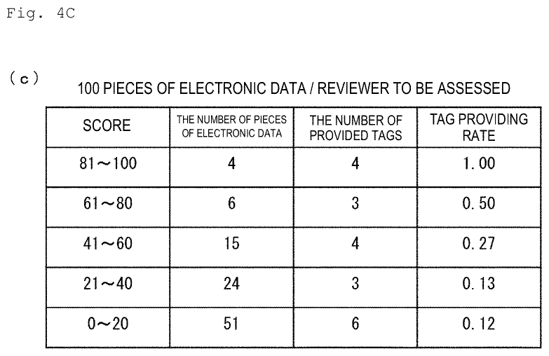

A second specific example of the accuracy evaluation processing S15 included in the reward setting method S1 illustrated in FIG. 2 will be described with reference to FIG. 4A. FIG. 4A is a flowchart illustrating flow of the accuracy evaluation processing S15 according to the present specific example.

In the accuracy evaluation processing S15 according to the present specific example, the controller 12 of the computer 1 executes score providing step S151 and accuracy evaluating step 152 as illustrated in FIG. 4A.

The score providing step S151 is step of providing a score indicating a rate (degree) that the electronic data Di satisfies the extraction conditions for each piece of electronic data Di included in an entire data set DS″ encompassing the data set DS. Note that, in the score providing step S151, an algorithm for providing a score is not particularly limited, and a publicly known algorithm can be used. As an example, the algorithm used in KIBIT (registered trademark), that is, an algorithm of providing a score in accordance with commonality of vocabularies with the electronic data confirmed as satisfying the extraction conditions can be used.

The accuracy evaluating step S152 is step of evaluating the review accuracy b of the reviewer to be assessed by comparing (1) distribution of scores of rates that the reviewer (either the reviewer to be assessed or other reviewers) judges that the electronic data satisfies the extraction conditions for the electronic data included in the entire data set DS″ (hereinafter, also referred to as “first score distribution”) with (2) distribution of scores of rates that the reviewer to be assessed judges that the electronic data satisfies the extraction conditions for the electronic data included in the data set DS (hereinafter, also referred to as “second score distribution”). The review accuracy b evaluated in the present accuracy evaluating step S152 can be, for example, similarity between the first score distribution and the second score distribution. The similarity between the first score distribution and the second score distribution can be calculated as, for example, correlation between the first score distribution and the second score distribution or an inner product of the first score distribution and the second score distribution.

An example of the accuracy evaluation processing S15 according to the present specific example will be described below with reference to of FIGS. 4B and 4C using an example of a case where the entire data set DS″ reviewed by five reviewers includes 500 pieces of electronic data, and the data set DS reviewed by the reviewer to be assessed includes 100 pieces of electronic data. FIGS. 4B and 4C are tables indicating an example of the accuracy evaluation processing S15 according to the present specific example.

First, the controller 12 classifies 500 pieces of electronic data included in the entire data set DS″ in accordance with classes of scores as illustrated in FIG. 4B. Here, the electronic data is classified into (1) electronic data whose score belongs to a class between 0 and 20, (2) electronic data whose score belongs to a class between 21 and 40, (3) electronic data whose score belongs to a class between 41 and 60, (4) electronic data whose score belongs to a class between 61 and 80, and (5) electronic data whose score belongs to a class between 81 and 100. The controller 12 then calculates a rate that the electronic data belonging to each class is judged by the reviewer as satisfying the extraction conditions (“tag providing rate” in FIG. 4B). As a result, the controller 12 can obtain score distribution of (0.08, 0.12, 0.25, 0.68, 0.95) as the above-described first score distribution.

The controller 12 then classifies 100 pieces of electronic data included in the data set DS in a similar manner to 500 pieces of electronic data included in the entire data set DS″, as illustrated in FIG. 4C. The controller 12 then calculates a rate that the electronic data belonging to each class is judged by the reviewer to be assessed as satisfying the extraction conditions (“tag providing rate” in FIG. 4C). As a result, the controller 12 obtains score distribution of (0.12, 0.13, 0.27, 0.50, 1.00) as the above-described second score distribution.

Finally, the controller 12 calculates similarity between the first score distribution (0.08, 0.12, 0.25, 0.68, 0.95) and the second score distribution (0.12, 0.13, 0.27, 0.50, 1.00) as the review accuracy b. For example, in a case where the similarity is evaluated as an inner product, the review accuracy b is c=0.08×0.12+0.12×0.13+0.25×0.27+0.68×0.5+0.95×1.0.

### Specific Example of Assessment Processing

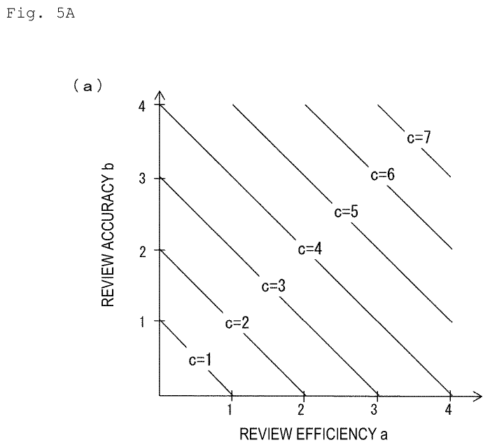

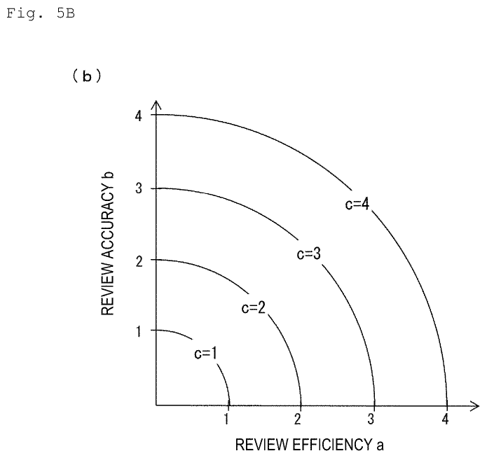

A specific example of the assessment processing S16 included in the reward setting method S1 illustrated in FIG. 2 will be described with reference to FIG. 5.

In the assessment processing S16 according to the present specific example, the controller 12 of the computer 1 calculates the review ability c=f(a, c) using a function f(a, b) determined in advance in which the review efficiency a and the review accuracy b are input and the review ability c is output.

As the function f(a, b), for example, a linear function f(a, b)=a+b as illustrated in FIG. 5A may be used, or a non-linear function f (a, b)={a²+b²}^{1/2} as illustrated in FIG. 5B may be used. The function is not particularly limited, if the function is such that as the review efficiency a is higher and the review accuracy b is higher, the review ability c becomes higher, and, as the review efficiency a is lower and the review accuracy b is lower, the review ability c becomes lower.

### Specific Example of Calculation Processing

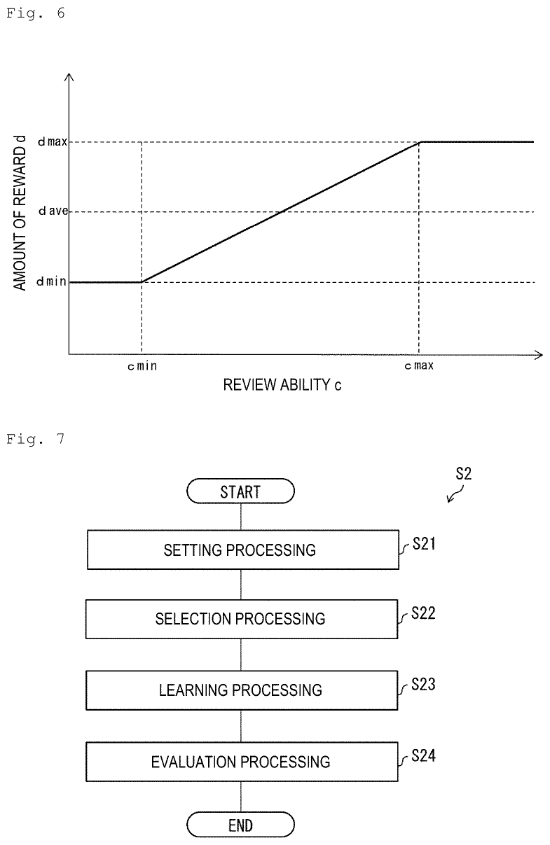

A specific example of the calculation processing S17 included in the reward setting method S1 illustrated in FIG. 2 will be described with reference to FIG. 6.

In the calculation processing S17 regarding the present specific example, the controller 12 of the computer 1 calculates the reward d=g(c) using a function g(c) determined in advance in which the review ability c is input, and the reward d is output.

As the function g(c), for example, a linear function g(c)=αc+β (where, when c<cmin, g(c)=dmin, when c>cmax, g(c)=gmax) having an upper limit value dmax and a lower limit value dmin as illustrated in FIG. 6 can be used. By this means, it becomes possible to set a reward within a range determined in advance (equal to or greater than dmin and equal to or less than dmax) in accordance with the review ability c.

Note that the lower limit value dmin and the upper limit value dmax of the reward d are preferably set as follows. (1) Total man-hours required for reviewing the entire data set DS″ are estimated, and total cost in accordance with the estimated total man-hours is estimated. (2) The number of required reviewers is calculated on the basis of the estimated total man-hours, and a total reward to be paid to the reviewers is calculated on the basis of the estimated total cost. (3) A standard reward per reviewer is calculated by dividing the calculated total reward by the calculated number of reviewers. (4) An amount obtained by adding an amount determined in advance (for example, hundred-thousand yen) to the standard reward is set as the upper limit value dmax of the reward d, and an amount obtained by subtracting the amount from the standard reward is set as the lower limit value dmin of the reward d.

### Application Examples

In a case where the reviewer judges that the electronic data Di satisfies the extraction conditions determined in advance (for example, the electronic data has relevance with a specific case) and provides a first tag to the electronic data Di, the reviewer may further provide a second tag indicating a genre of the electronic data Di. A criterion for providing the second tag can be set as appropriate. In the assessment processing S16, the controller 12 of the computer 1 may assess the review ability of the reviewer for each genre. By this means, it is possible to evaluate genres which each reviewer is good at and not good at. Therefore, because a contractor (business operator) who undertakes the review work or a check worker such as an attorney can allocate review work of the electronic data Di belonging to a genre which the reviewer is good at to each reviewer, it is possible to further improve efficiency of the whole review work.

Further, in a case where the reviewer has a question in the review work, the reviewer can ask a question to the checker using chat, or the like. In the assessment processing S16, the controller 12 of the computer 1 may determine whether or not the reviewer to be assessed makes an effort to improve review accuracy by performing text analysis on question history regarding the review work of the reviewer to be assessed and may make assessment in accordance with a determination result. By this means, the controller 12 can improve accuracy for assessing the reviewer to be assessed.

The controller 12 of the computer 1 may determine the electronic data Di to be allocated to each reviewer in accordance with the review ability of each reviewer. For example, it is possible to allocate electronic data Di which is highly likely to satisfy the extraction conditions (for example, with high scores described above) to a “reviewer who has low review efficiency but has high review accuracy”, and allocate electronic data Di which is less likely to satisfy the extraction conditions (for example, with low scores described above) to a “reviewer who has high review efficiency but has low review accuracy”. By this means, it is possible to improve review efficiency of the whole review work while improving review accuracy of the whole review work.

### Definition of Each Feature Amount

Among attribute values of the text T, the attribute value which can be utilized as the first feature amount C1 includes, for example, the number of types of words, the number of word classes, a TTR, a CTTR, a Yule's K characteristic value, the number of dependencies, a ratio of numerical values, or the like. These attribute values can be defined, for example, as follows.

The number of types of words (the number of vocabularies) of the text T can be, for example, defined as the number of different words appearing in the text T. For example, in a case where the text T is “sumomo mo momo mo momo no uchi” (meaning “both plums and peaches are a kind of peach” in English), morphemes of the text T can be morphologically analyzed to “sumomo (plums)/ mo (and)/ momo (peaches)/ mo (both)/ momo (peach)/ no (of)/ uchi (a kind)”, and, because five different words of “sumomo”, “mo”, “momo”, “no” and “uchi” appear in the text T, the number of types of words of the text T is five. Here, it should be noted that the word of “momo” which appears twice is not individually counted (a morpheme of “mo” which appears twice is not individually counted in a similar manner).

The number of word classes of the text T can be, for example, defined as the number of word classes appearing in the text T. For example, in a case where the text T is “sumomo mo momo mo momo no uchi”, morphemes of the text T can be morphologically analyzed to “sumomo (noun) / mo (particle) / momo (noun) / mo (particle) / momo (noun) / no (particle) / uchi (noun)”, and, because two word classes of a noun and a particle appear in the text T, the number of word classes of the text T is two.

The TTR of the text T can be, for example, defined using the following expression (1) while setting the number of words of the text T as N and setting the number of types of words of the text T as V. For example, in a case where the text T is “sumomo mo momo mo momo no uchi”, morphemes of the text T can be morphologically analyzed to “sumomo / mo / momo / mo / momo / no / uchi”, and, because the number of words is seven and the number of types of words is five, the TTR of the text T is 5//7≈0.714.

$$\begin{matrix}[ Expression 1 ] & \\ TTR = \frac{V}{N} & ( 1 )\end{matrix}$$

The CTTR of the text T can be, for example defined using the following expression (2) while setting the number of words of the text T as N and setting the number of types of words of the text T as V. For example, in a case where the text T is “sumomo mo momo mo momo no uchi”, morphemes of the text T can be morphologically analyzed to “sumomo / mo / momo / mo / momo / no / uchi”, and, because the number of words is seven, and the number of types of words is five, the CTTR of the text T is 5/(2×7)^{1/2}≈1.34.

$$\begin{matrix}[ Expression 2 ] & \\ CTTR = \frac{V}{\sqrt{2 N}} & ( 2 )\end{matrix}$$

The Yule's K characteristic value of the text T can be, for example, defined using the following expression (3) while setting the number of words of the text T as N and setting the number of words appearing in the text T m times as V(m). For example, in a case where the text T is “sumomo mo momo mo momo no uchi”, morphemes of the text T can be morphologically analyzed to “sumomo / mo / momo / mo / momo / no / uchi”, and, because the number of words is seven, three words of “sumomo”, “no” and “uchi” appear in the text T once, and two words of “momo” and “mo” appear in the text T twice, the Yule's K characteristic value of the text T is 10⁴×(3×1²+2×2²−7)/7²≈816.

$$\begin{matrix}[ Expression 3 ] & \\ K = {10}^{4} \frac{{\sum }_{m} V ( m ) {m}^{2} - N}{{N}^{2}} & ( 3 )\end{matrix}$$

The number of dependencies in the text T can be defined as the total of the number of edges (arcs) in a semantic dependency graph of each sentence included in the text T, for example. For example, when the text T is “watashi wa raamen wo tabe ni Tokyo e iku (meaning “I go to Tokyo to eat ramen” in English). Tokyo no raamen wa oishii (meaning “ramen in Tokyo is delicious” in English).”, there are four edges in the semantic dependency graph of the first sentence, which are “watashi wa (I)→iku (go)”, “Tokyo ni (to Tokyo)→iku (go)”, “raamen wo (ramen)→tabe ni (to eat)”, and “tabe ni (to eat)→iku (go)”, and there are two edges in the semantic dependency graph of the second sentence, which are “Tokyo no (in Tokyo)→raamen (ramen)” and “raamen wa (ramen)→oishii (is delicious)”. Therefore, the number of dependencies in the text T is 6.

The ratio of numerical values of the text T can be, for example defined as a value of a ratio of the number of numbers of the text T (the number of numbers included in the text T) with respect to the number of characters of the text T, or a value of a ratio of the number of numerical values of the text T (the number of numerical values included in the text T. Successive numbers are counted as one numerical value) with respect to the number of words of the text T. For example, in a case where the text T is “Ramen is 650 yen”, the ratio of numerical values of the text T is 3/11≈0.272 (former definition) or 1/5=0.2 (latter definition).

Among the attributes of the text T, the attribute which can be utilized as the second feature amount C2 includes, for example, the number of characters, the number of words, the number of sentences, the number of paragraphs, or the like. These attributes can be, for example, defined as follows.

The number of characters of the text T can be, for example, defined as the number of characters included in the text T. For example, in a case where the text T is “sumomo mo momo mo momo no uchi”, the number of characters in the text T in Japanese is 12. Here, it should be noted that a character of “mo” which appears six times is individually counted.

The number of words of the text T can be, for example, defined as the number of words (morphemes) included in the text T. For example, in a case where the text T is “sumomo mo momo mo momo no uchi”, because morphemes of the text T can be morphologically analyzed to “sumomo / mo / momo / mo / momo / no / uchi”, the number of words of the text T is seven. Here, it should be noted that the word of “momo” which appears twice is individually counted (the word of “mo” which appears twice is also individually counted in a similar manner).

The number of sentences of the text T can be, for example, defined as the number of sentences included in the text T. The number of sentences of the text T can be specified by, for example, counting the number of separators of sentences (for example, points) included in the text T.

The number of paragraphs of the text T can be, for example, defined as the number of paragraphs included in the text T. The number of paragraphs of the text T can be specified by, for example, counting the number of separators of paragraphs (for example, line feed codes) included in the text T.

Note that the above-described definition of each attribute value (feature amount) of the text T is merely one specific example for presenting one implementation example of the reward setting method S1, and can be changed as appropriate. That is, each attribute value of the text T can be specified with definition different from the above-described definition within a range not inconsistent with its concept. For example, the TTR of the text T quantitatively expresses concept of “abundance of vocabularies”, and may be specified using the above-described definition (TTR=V/N) or may be specified using definition (for example, TTR=Log(V)/Log (N), or the like), different from the above-described definition.

### <Construction Method of Prediction Model>

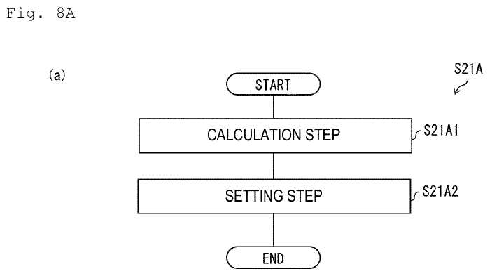

The construction method S2 of the prediction model will be described with reference to FIG. 7. FIG. 7 is a flowchart illustrating flow of the construction method S2 of the prediction model.

The construction method S2, which is a method for constructing the prediction model to be utilized in the prediction processing S13 described above using the computer 1, is implemented prior to the extraction processing S12 described above, as part of the reward setting method S1 described above. As illustrated in FIG. 7, the construction method S2 includes setting processing S21, selection processing S22, learning processing S23 and evaluation processing S24.

The setting processing S21 is processing of setting a degree of importance of each attribute included in an attribute group GA determined in advance with reference to part or all of a sample data group. In the setting processing S21, the degree of importance of an attribute which more greatly affects the review period is set higher, and the degree of importance of an attribute which less affects the review period is set lower. The setting processing S21 is executed by the controller 12 of the computer 1.

Here, the sample data group indicates a set of sample data including text for which the review period is actually measured in advance. The sample data group is, for example, stored in the auxiliary memory 13 incorporated in the computer 1 or an external storage (not illustrated in FIG. 1) connected to the computer 1. Further, the attribute group GA is a set of attributes of text determined in advance. Examples of the attribute of the text which can be an element of the attribute group GA can include the number of types of words, the number of word classes, the TTR, the CTTR, the Yule's K characteristic value, the number of dependencies, and the ratio of numerical values (which are attributes for which attribute values can be the first feature amount C1), and the number of characters, the number of words, the number of sentences, and the number of paragraphs (which are attributes for which attribute values can be the second feature amount C2), the degree of positiveness and the degree of negativeness (which are attributes for which attribute values can be the third feature amount C3), or the like. Note that a specific example of the setting processing S21 will be described later with reference to different drawings.

The selection processing S22 is processing of selecting attributes for which attribute values are to be included in the feature amount group GC, from the attribute group GA. In the selection processing S22, an attribute for which a higher degree of importance is set in the setting processing S21 is preferentially selected. For example, attributes of the number determined in advance are selected in descending order of the degree of importance set in the setting processing S21. The selection processing S22 is executed by the controller 12 of the computer 1 after the setting processing S21 is executed.

The learning processing S23 is processing of causing the prediction model in which the attributes selected in the selection processing S22 are input (explanatory variables) and the review period is output (target variable), to perform machine learning so as to improve prediction accuracy, with reference to part or all of the sample data included in the sample data group. The learning processing S23 is executed by the controller 12 of the computer 1 after the selection processing S22 is executed. Note that the learning processing S23 may be implemented with reference to all of the sample data which can be referred to or may be implemented with reference to part of the sample data which can be referred to. Further, the learning processing S23 may be implemented with reference to sample data which is the same as the sample data referred to in the setting processing S21 or may be implemented with reference to sample data different from the sample data referred to in the setting processing S21.

Note that, to make the learning processing S23 more efficient, tuning processing may be executed before the learning processing S23 is executed. Here, the tuning processing refers to processing of tuning hyper parameters of the prediction model. Examples of a method for tuning parameters (searching parameters) can include, for example, grid search, random search, Bayesian optimization, meta-heuristic search, or the like. Which method should be utilized may be determined while learning speed of the model is taken into account by performing benchmarking testing.

Further, to obtain a prediction model having accuracy determined in advance, evaluation processing may be executed after the learning processing S23 is executed. Here, the evaluation processing refers to processing of evaluating prediction accuracy of the prediction model (for example, a difference between a review period predicted by the prediction model and an actually measured review period) using sample data which is not utilized in the learning processing S23 among the sample data included in the sample data group. Further, to efficiently implement the learning processing S23 and the evaluation processing, a publicly known K-Fold Cross Validation method may be used.

According to the construction method S2, it is possible to construct a prediction model in which attributes which greatly affect the review period, selected in the selection processing S22, are input. Therefore, it is possible to reduce calculation cost compared to the prediction model in which all attributes are input, and construct a prediction model with higher prediction accuracy compared to the prediction model in which randomly selected attributes are input.

### First Specific Example of Setting Processing

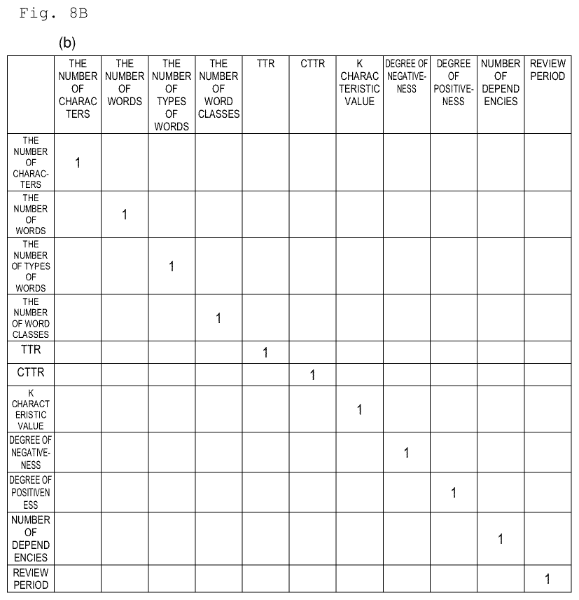

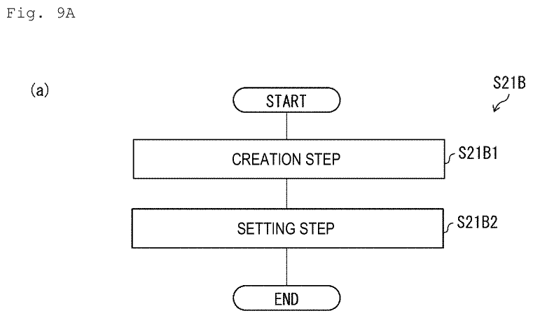

A first specific example of the setting processing S21 (hereinafter, referred to as “setting processing S21A”) will be described with reference to FIG. 8. FIG. 8A is a flowchart illustrating flow of the setting processing S21A.

As illustrated in FIG. 8A, the setting processing S21A includes calculation step S21A1 and setting step S21A2.

The calculation step S21A1 is step of calculating a correlation coefficient between each attribute included in the attribute group GA and an actually measured review period with reference to part or all of the sample data group. The calculation step S21A1 is executed by the controller 12 of the computer 1.

The setting step S21A2 is step of setting the degree of importance of each attribute included in the attribute group GA at a value in accordance with the correlation coefficient corresponding to the attribute, calculated in the calculation step S21A1. Note that the setting step S21A2 is executed by the controller 12 of the computer 1 after the calculation step S21A1 is executed.

Note that the degree of importance of each attribute set in the setting step S21A2 may be, for example, the correlation coefficient itself corresponding to the attribute or may be a different numerical value calculated from the correlation coefficient corresponding to the attribute. However, the degree of importance of each attribute set in the setting step S21A2 is preferably set such that the degree of importance becomes higher as the correlation coefficient corresponding to the attribute becomes higher, and becomes lower as the correlation coefficient corresponding to the attribute becomes lower.

Further, the degree of importance of each attribute set in the setting step S21A2 may be set while a correlation coefficient between the attribute and another attribute as well as the correlation coefficient between the attribute and the review period is taken into account. In this case, a correlation matrix as illustrated in FIG. 8B is created. Then, in a case where the correlation coefficient between the two attributes is greater than a threshold determined in advance, the degree of importance of the attribute is set lower so that one attribute is not selected in the selection processing S22. By this means, it is possible to reduce multicollinearity of the prediction model.

### Second Specific Example of Setting Processing

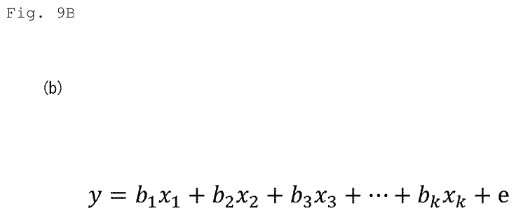

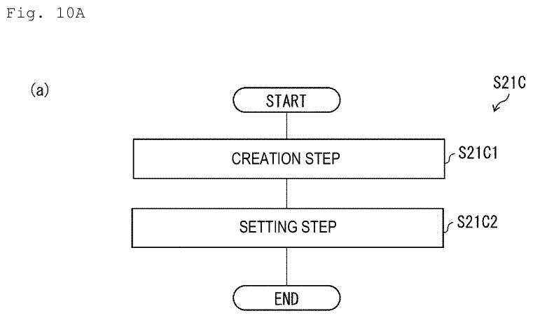

A second specific example of the setting processing S21 (hereinafter, referred to as “setting processing S21B”) will be described with reference to FIG. 9. FIG. 9A is a flowchart illustrating flow of the setting processing S21B.

As illustrated in FIG. 9A, the setting processing S21B includes creation step S21B1 and setting step S21B2.

The creation step S21B1 is step of creating a multiple regression expression in which each attribute included in the attribute group GA is set as an explanatory variable, and the review period is set as a target variable, with reference to the sample data group. An example of the multiple regression expression created in the creation step S21B1 is indicated in FIG. 9B. The multiple regression expression indicated in FIG. 9B is a multiple regression expression in which attributes x₁, x₂, . . . , xₖ included in the attribute group GA are set as explanatory variables and the review period y is set as the target variable. In the multiple regression expression indicated in FIG. 9B, b₁, b₂, . . . , bₖ are partial regression variables, and e is an error. The creation step S21B1 is executed by the controller 12 of the computer 1.

The setting step S21B2 is step of setting the degree of importance of each attribute included in the attribute group GA at a value in accordance with a magnitude of the partial regression coefficient corresponding to the attribute in the multiple regression expression created in the creation step S21B1. The setting step S21B2 is executed by the controller 12 of the computer 1 after the creation step S21B1 is executed.

Note that the degree of importance of each attribute set in the setting step S21B2 may be, for example, a magnitude itself of the partial regression coefficient corresponding to the attribute or may be a different numerical value calculated from the magnitude of the partial regression coefficient corresponding to the attribute. However, the degree of importance of each attribute set in the setting step S21B2 is preferably set such that the degree of importance becomes higher as the magnitude of the partial regression coefficient corresponding to the attribute becomes greater, and becomes lower as the magnitude of the partial regression coefficient corresponding to the attribute becomes smaller.

According to the present specific example, it is possible to utilize the multiple regression expression in which terms corresponding to the attributes selected in the selection processing S22 are eliminated from the multiple regression expression created in the creation step S21B1, as the prediction model to be used in the prediction processing S13. Therefore, it is possible to omit the learning processing S23 when the construction method S2 is implemented. Accordingly, it is possible to keep calculation cost required for implementing the construction method S2 low.

### Third Specific Example of Setting Processing

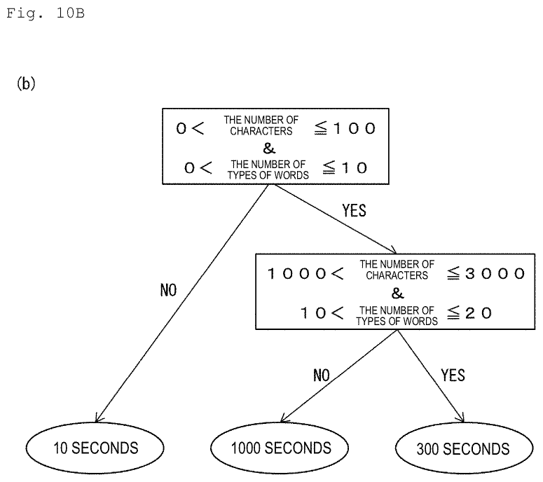

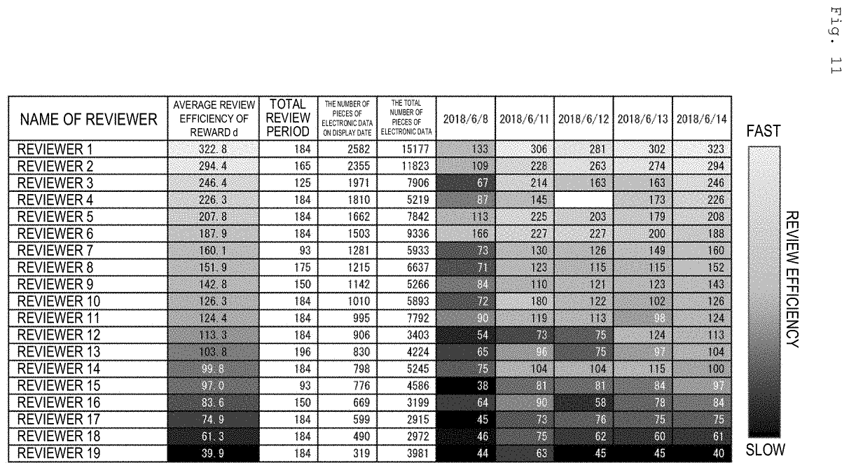

A third specific example of the setting processing S21 (hereinafter, referred to as “setting processing S21C”) will be described with reference to FIG. 10. FIG. 10A is a flowchart illustrating flow of the setting processing S21C.

As illustrated in FIG. 10A, the setting processing S21C includes creation step S21C1 and setting step S21C2.

The creation step S21C1 is step of creating a regression tree in which each attribute included in the attribute group GA is set as an explanatory variable, and the review period is set as a target variable, with reference to the sample data described above. An example of the regression tree created in the creation step S21C1 is illustrated in FIG. 10B. The creation step S21C1 is executed by the controller 12 of the computer 1. Note that, as a method for creating a regression tree, for example, XGBoost can be used.

The setting step S21C2 is step of setting a degree of importance of each attribute included in the attribute group GA at a value in accordance with a magnitude of change of output of the regression tree, which changes by a branch condition corresponding to the attribute being changed in the regression tree created in the creation step S21C1. The setting step S21C2 is executed by the controller 12 of the computer 1 after the creation step S21C1 is executed.

Note that the degree of importance of each attribute set in the setting step S21C2 may be, for example, the magnitude itself of change of output corresponding to the attribute, or may be a different numerical value calculated from the magnitude of change of output corresponding to the attribute. However, the degree of importance of each attribute set in the setting step S21C2 is preferably set such that the degree of importance becomes higher as the magnitude of change of output corresponding to the attribute becomes greater, and becomes lower as the magnitude of change of output corresponding to the attribute becomes smaller.

According to the present specific example, it is possible to utilize a regression tree in which the branch conditions corresponding to the attributes selected in the selection processing S22 are eliminated from the regression tree created in the creation step S21C1, as the prediction model to be used in the prediction processing S13. Therefore, it is possible to omit the learning processing S23 when the construction method S2 is implemented. Accordingly, it is possible to keep calculation cost required for implementing the construction method S2 low.

### <Visualization of Review Efficiency>

The computer 1 may further execute processing of visualizing the review efficiency of the reviewer to be assessed evaluated in the efficiency evaluation processing S14 and outputting (for example, displaying or printing) the visualized review efficiency using the output device 3 (for example, a display or a printer).

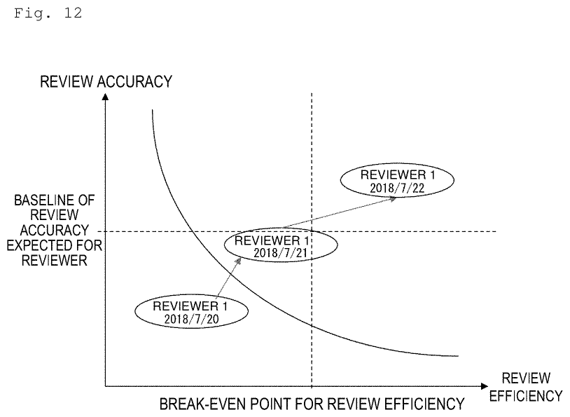

FIG. 11 is an example of an output image output using the output device 3. This output image includes a table in which a list of review efficiency of a plurality of reviewers to be assessed is displayed. This table indicates (1) name of the reviewer, (2) average review efficiency (an average of the number of pieces of electronic data reviewed per unit time) of the reviewer, (3) total hours taken for the reviewer to perform review, (4) the number of pieces of electronic data reviewed by the reviewer on display date of the table, (5) the total number of pieces of electronic data reviewed by the reviewer, and (6) review efficiency of the reviewer of the last five days (the number of piece of electronic data reviewed by the reviewer per unit time in each day), for each of the plurality of reviewers to be assessed.

Note that the table indicated in FIG. 11 is merely an example, and the displayed table may include other indexes relating to the review efficiency of the reviewer. Further, while, in the table indicated in FIG. 11, the review efficiency is indicated with numerical values as “the number of pieces of electronic data reviewed per unit time”, the review efficiency may be indicated in other forms (for example, ranking from A to E, performance rating of excellent, good and passing).

The computer 1 can output the above-described table using an arbitrary output device 3 (such as, for example, a display and a printer). At this time, the computer 1 can, for example, color cells (elements of the table) indicating the review efficiency using gradation (continuous change of color) in accordance with the review efficiency. For example, the computer 1 can color the respective cells so that lighter color indicates higher review efficiency and darker color indicates lower review efficiency. By this means, the computer 1 can allow the review efficiency of each reviewer to be easily visually confirmed.

Note that a method for allowing the review efficiency to be easily visually confirmed through gradation is merely an example, and the computer 1 can employ other methods which improve visibility of the review efficiency. For example, it is also possible to improve visibility by changing font of numbers indicating the review efficiency in accordance with the review efficiency (for example, making font larger or thicker as the review efficiency becomes higher).

### <Visualization of Change of Ability of Reviewer>

The computer 1 may further execute processing of visualizing change of review ability of the reviewer to be assessed, assessed in the assessment processing S16 and outputting (for example, displaying or printing) the visualized change using the output device 3 (for example, a display or a printer).

FIG. 12 is an example of an output image output using the output device 3. This output image includes a graph which visualizes change of ability of a reviewer 1 by indicating the review efficiency of the reviewer 1 on a horizontal axis and indicating the review accuracy of the reviewer 1 on a vertical axis. This graph indicates that an ellipse indicating the review ability of the reviewer to be assessed (in FIG. 12, described as the “reviewer 1”) moves from a lower left part to an upper right part in the graph as time passes. By this means, it can be easily recognized that the reviewer to be assessed improves his/her review ability in three days.

Inversely, in a case where the ellipse indicating the review ability moves from the upper right part to the lower left part, it can be easily recognized that the reviewer to be assessed lowers his/her review ability. Therefore, a review supervisor who supervises review work of the reviewer can take appropriate measures on the basis of the recognition (for example, replaces the reviewer, changes a type of document to be allocated to the reviewer, or the like).

Note that a line (indicated with a dotted line) orthogonal to the review efficiency axis indicates a break-even point for the review efficiency. That is, the line indicates a baseline at which a money-losing situation may occur in a case where labor cost per person (an amount obtained by dividing a total amount of labor cost estimated for the review work by the number of reviewers) is paid as rewards to reviewers located on a left side of the line (reviewers whose review efficiency falls below predetermined review efficiency). Further, a line (indicated with a dotted line) orthogonal to the review accuracy axis indicates a baseline of the review accuracy expected for the reviewer. That is, the line indicates a baseline at which load of examining work after the review is completed may increase in a case where reviewers located below the line (reviewers whose review accuracy falls below the expected review accuracy) are caused to perform review.

Further, an arc-like curve included in the output image indicates a threshold of the review ability expected for the reviewer. That is, it is expected so that ability of each reviewer is expected to be located on a right and upper side of this curve. In this manner, by visualizing the review ability expected for the reviewers and actual review ability, it is possible to facilitate management of the reviewers and improve efficiency of the whole review work.

### <Type of Data>

While, in the present embodiment, description has been mainly provided assuming that electronic data is “text data”, the “electronic data” may include all arbitrary types of electronic data expressed in a form which can be processed by the above-described computer 1. The above-described data may be, for example, unstructured data whose structural definition is at least partially incomplete, and widely includes document data at least partially including text written in natural language (such as, for example, e-mails (including attachment files and header information), technical documents (widely including documents explaining technical matters such as, for example, academic papers, patent publication, product specification and designs), presentation materials, spreadsheet information, financial statements, meeting materials, reports, sales materials, contracts, organization charts, business plans, business analysis information, electronic health records, web pages, blogs and comments posted to social networking service), sound data (for example, data obtained by recording conversation, music, or the like), image data (for example, data including a plurality of pixels or vector information), video data (for example, data including a plurality of frame images), or the like.

Note that each aspect of the present disclosure can be, for example, suitably applied to review work for selecting data to be submitted to the US federal court in discovery. However, review work to which each aspect of the present disclosure can be applied is not limited to the review work for discovery. Each aspect of the present disclosure can be widely applied in an arbitrary situation which requires man-powered review work to extract desired electronic data from a large volume of electronic data.

### <Supplementary Note>

The present disclosure is not limited to the above-described respective embodiments, and can be changed in various manners within a scope recited in the claims, and embodiments obtained by combining technical means respectively disclosed in different embodiments as appropriate are also incorporated in the technical scope of the present disclosure. Further, new technical features can be formed by combining technical means respectively disclosed in the respective embodiments.

This application claims the benefit of foreign priority to Japanese Patent Applications No. JP2018-203079, filed Oct. 29, 2018, which is incorporated by reference in its entirety.

What is claimed is:

1. An assessment method for assessing review ability of a reviewer to be assessed who reviews a data set using a computer including a controller and a memory which stores the data set including at least one piece of electronic data, the assessment method comprising:
efficiency evaluation processing executed by the controller evaluating review efficiency of the reviewer to be assessed in accordance with a predicted review period of each piece of electronic data and an actual review period actually taken for the reviewer to be assessed to do review work on the electronic data;
accuracy evaluation processing executed by the controller evaluating review accuracy of the reviewer to be assessed by examining a review result obtained by the reviewer to be assessed reviewing the data set; and
assessment processing executed by the controller assessing the review ability of the reviewer to be assessed in accordance with the review efficiency evaluated in the efficiency evaluation processing and the review accuracy evaluated in the accuracy evaluation processing.

2. The assessment method according to claim 1, further comprising:
prediction processing executed by the controller calculating the predicted review period in accordance with a prediction model constructed in advance using a reviewed data set; and
measurement processing executed by the controller measuring the actual review period,
wherein the efficiency evaluation processing is processing of evaluating the review efficiency of the reviewer to be assessed from the actual review period obtained in the measurement processing on a basis of the predicted review period obtained in the prediction processing.

3. The assessment method according to claim 1,
wherein the prediction model is a prediction model in which a feature amount of content of each piece of electronic data is input and a predicted review period of the electronic data is output, and is a prediction model constructed through machine learning which uses the reviewed data set as learning data.

4. The assessment method according to claim 1,
wherein the review work is work of judging whether or not electronic data satisfies extraction conditions determined in advance, and
the accuracy evaluation processing is processing of evaluating the review accuracy of the reviewer to be assessed by comparing a judgment result in the review work by the reviewer to be assessed with a judgment result in the review work by a reviewer other than the reviewer to be assessed.

5. The assessment method according to claim 1,
wherein the assessment processing is processing of assessing the review ability of the reviewer to be assessed using an algorithm determined in advance in which the review efficiency and the review accuracy of the reviewer to be assessed are input and the review ability of the reviewer to be assessed is output.

6. The assessment method according to claim 1, further comprising:
efficiency output processing executed by the controller visualizing the review efficiency and outputting the visualized review efficiency.

7. The assessment method according to claim 1, further comprising:
ability output processing executed by the controller visualizing the review ability and outputting the visualized review ability.

8. A reward setting method for setting a reward to be paid to a reviewer in accordance with ability of the reviewer assessed using the assessment method according to claim 1, the reward setting method comprising:
calculation processing of calculating the reward so that, when review ability of a first reviewer assessed using the assessment method is higher than review ability of a second reviewer assessed using the assessment method, a reward to be paid to the first reviewer becomes more than a reward to be paid to the second reviewer.

9. The reward setting method according to claim 8,
wherein the calculation processing is processing of calculating the reward so as not to fall below a lower limit value of the reward determined in advance and so as not to exceed an upper limit value of the reward determined in advance.

10. A computer including a memory which stores a data set including at least one piece of electronic data, and a controller, and assessing review ability of a reviewer to be assessed who reviews the data set,
the controller executing:
efficiency evaluation processing of evaluating review efficiency of the reviewer to be assessed in accordance with a predicted review period of each piece of electronic data and an actual review period actually taken for the reviewer to be assessed to do review work on the electronic data;
accuracy evaluation processing of evaluating review accuracy of the reviewer to be assessed by examining a review result obtained by the reviewer to be assessed reviewing the data set; and
assessment processing of assessing the review ability of the reviewer to be assessed in accordance with the review efficiency evaluated in the efficiency evaluation processing and the review accuracy evaluated in the accuracy evaluation processing.
